(19) United States
(12) Patent Application Publication
(10) Pub. No.: US 2006/0057327 A1
(43) Pub. Date: Mar. 16, 2006

(54) Method and apparatus for manufacturing ceramic devices

(76) Inventors: Richard Topliss, Cambridge (GB); David Charles William Richards, Cambridge (GB)

Correspondence Address: NIXON & VANDERHYE, PC, 901 NORTH GLEBE ROAD, 11TH FLOOR, ARLINGTON, VA, 22203, US

(21) Appl. No.: 10/544,176

(22) PCT Filed: Feb. 9, 2004
(86) PCT No.: PCT/GB04/00485

§ 371 Date: Nov. 2, 2005

(30) Foreign Application Priority Data
Feb. 12, 2003 (GB) 03031507

(51) Int. Cl. B32B 3/02; B31C 1/00; B29C 53/82

(52) U.S. Cl. 428/64.1; 156/184; 156/425

(57) ABSTRACT

An apparatus for manufacturing a ceramic device from tape (21) in a green state comprises a cylindrical rod (23) as a first forming element, a first clamping system (241) for fixing a first end of the tape (21) with respect to the cylindrical rod (23) and a first mechanism (20, 231) for winding the tape (21) around the cylindrical rod (23) to preform the tape (21). The apparatus further comprises a second forming element (33), a second clamping system (351, 352) for fixing at least one end of the pre-formed tape (21) with respect to the second forming element (33), and a second mechanism (331, 351) which winds the pre-formed tape (21) around the second forming element (33).

This invention relates to a method and apparatus for manufacturing curved elements of electro-active material. More particularly, it relates to a method and apparatus for manufacturing electro-active actuators curved around an axis which is itself curved.

Comparably large translation displacements have been recently achieved by using a curved, helical structure of coiled piezoelectric tape in which a multilayer tape is curved helically around an axis which is itself curved. Such devices are found to easily exhibit displacement in the order of millimetres on an active length of the order of centimetres. These structures and variations thereof are described, for example, in WO-01/47041 and in D. H. Pearce et al., Sensors and Actuators A 100 (2002), 281-286.

These structures are ceramic devices of complex curved shape and are currently manufactured using inefficient low output methods which rely heavily on human labor. Other methods using extrusion processes are described for example in WO-02/103819. However the described process may not be feasible for all configurations of super-helical actuators.

Therefore it is seen as an object of the invention to provide a method and apparatus for manufacturing twice coiled actuators with limited human involvement and using flat ceramic tape as base material.

According to an aspect of the invention, there is provided a method of and an apparatus for manufacturing ceramic devices including the steps of transporting ceramic tape in a green state into the proximity of a first forming element; fixing a first end of the tape with respect to the first forming element; moving the tape and first forming element relatively to each other in a motion including simultaneously rotational and translational movements, thus winding the tape around the first forming element; removing the fixing of a first end thereby allowing separation of the tape and first forming element to generate a helically wound pre-formed tape; fixing at least one end of the pre-formed tape with respect to a second forming element; and moving the pre-formed tape and second forming element relatively to each other in a motion including at least a rotational movement, thus winding the pre-formed tape around the second forming element.

The invention preferably includes the step of and devices for moving the tape and the first forming element relatively to each other including the step of continuously pressing during the movement the tape onto the first forming element at a zone where the tape first contacts the first forming element.

Furthermore the invention preferably includes the step of exerting a force on the edge of the tape at a zone where the tape first contacts the first forming element to prevent slippage of the tape relative to the first forming element.

The invention preferably includes the step of and devices for closing a second clamping element around the first end of the tape before releasing a first clamping element fixing the tape to the first forming element.

Preferably, the clamping elements used for gripping the tape or other devices designed to exert pressure directly onto the tape are pneumatically operated or spring-loaded to simulate a “tactile” handling of the tape.

The invention preferably includes the step of and devices for passing the first forming element along an edge holding back the pre-formed tape.

Preferably the pre-formed tape is held at both ends using clamping elements with one of the clamping elements fixing one end of the pre-formed tape with respect to the second forming element while the other clamping element performs a rotational movement around the second forming element.

The invention preferably includes the step of and devices for removing the fixing with respect to the second forming element and transferring the wound pre-formed tape onto a support structure; and placing the support structure into heated environment for drying and/or sintering.

The present invention is particularly advantageous used to manufacture twice-coiled helices, particularly twice-coiled actuators of piezoelectric material.

These and other aspects of inventions will be apparent from the following detailed description of non-limitative examples making reference to the following drawings.

In the drawings:

FIG. 1 is a perspective view of a twice-coiled actuator as known;

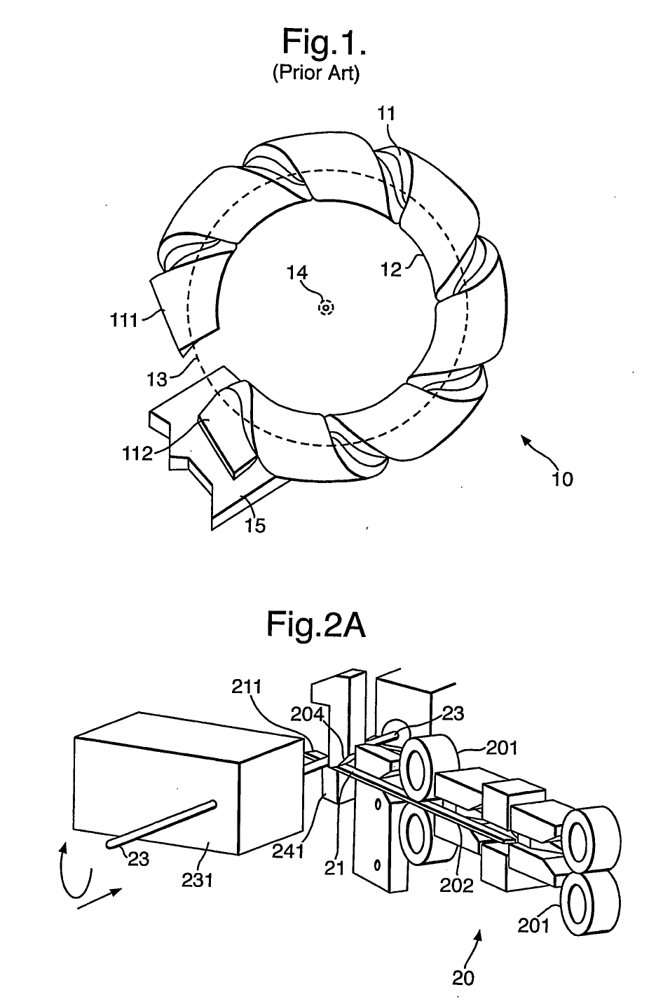

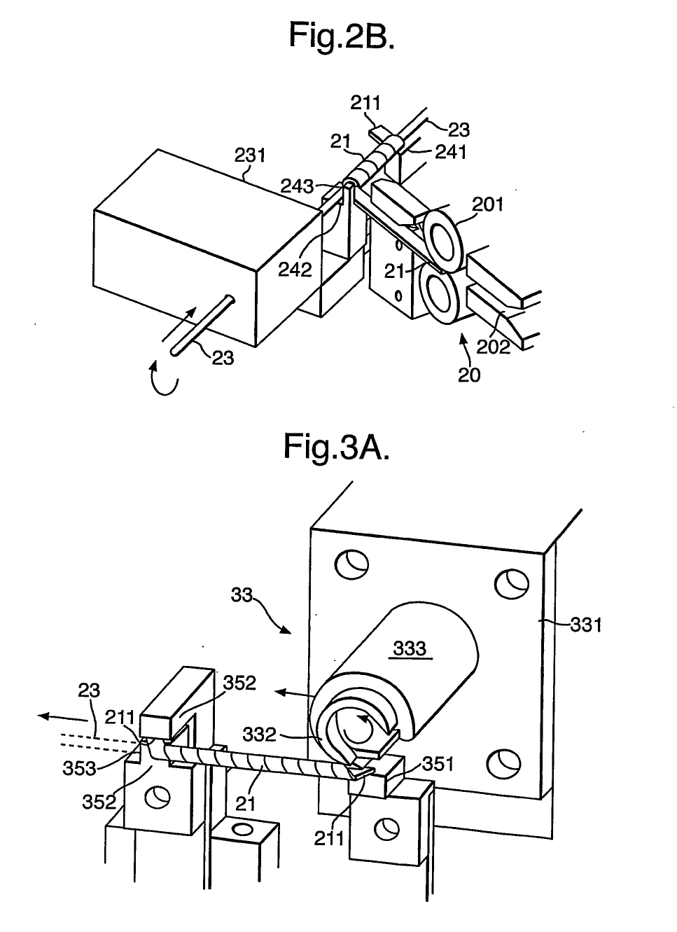

FIG. 2 illustrates a first forming step in accordance with an example of the present invention;

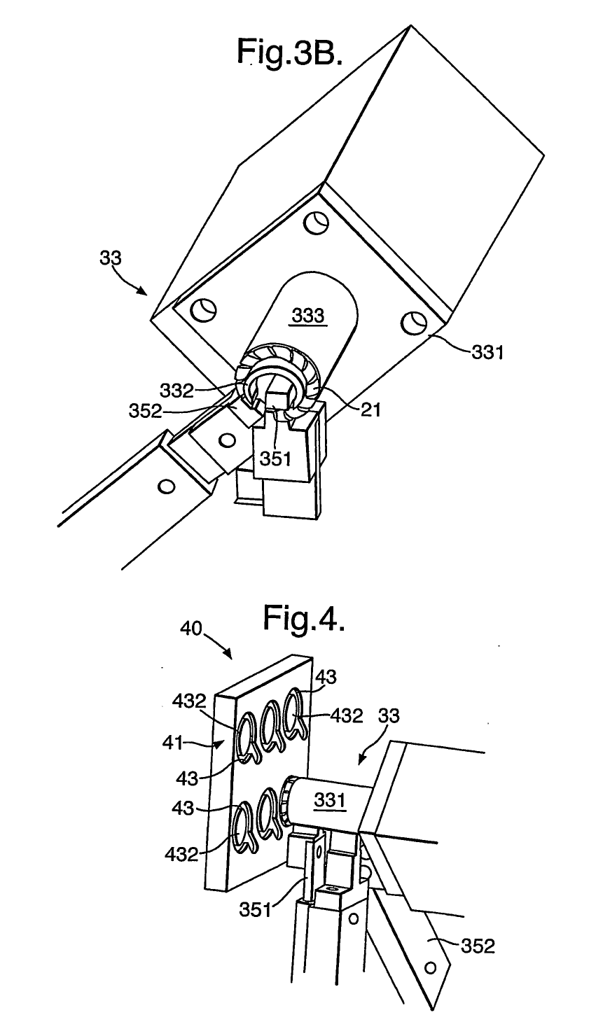

FIG. 3A illustrates a step of releasing pre-formed tape from a first forming element;

FIG. 3B illustrates a second forming step in accordance with an example of the present invention; and

FIG. 4 illustrates the transfer of formed tape onto a support structure for drying.

FIG. 1 shows a known actuator 10 of the type described in WO-01/47041 and Sensors and Actuators A 100 (2002), 281-286.

The actuator 10 has a curved portion 12 of multi-layer tape 11, for example of a bimorph construction, that is wound helically around a first axis 13 referred to as the minor axis. For illustration, the minor axis is shown as a dashed line 13 in FIG. 1. The helically wound portion is further coiled into a secondary winding of about three quarters of a complete turn. The axis 14 of this secondary winding is referred to as the major axis and shown as a small dashed circle 14 with a central solid point again to facilitate description and illustration. The first winding is known as the primary winding or primary helix. The secondary winding could be any curve and could exceed one turn and form a spiral or secondary helix. It is therefore usually referred to as secondary curve. The tape is arranged on actuation to bend around the minor axis 13. Due to the helical curve around the minor axis, such bending is concomitant with twisting of the actuator 10 around the minor axis. Due to the curve around the major axis 14, such twisting is concomitant with relative displacement of the ends 111, 112 of the actuator 10. When used as an actuator, one end 111 of the tape 11 may be fixed to a moveable object (not shown) while the other end 112 of the tape 11 may be mounted onto a base plate 15.

The manufacture of the actuator 10 from a precursor ceramic tape is a very complex task usually performed by manual labor. It involves the steps of slowly winding a helix of the tape around a cylindrical rod and, and after carefully removing the rod, placing the helix into a “sagger” that supports the helix in its coiled form during subsequent drying until the ceramic tape is sufficiently stiff to support its own weight. The coiled helix is then burned to remove binder and other organic components and sintered to form the ceramic actuator.

While the above steps can be performed manually, the process does not readily lend itself for automation. The properties of the precursor ceramic tape are such that, though pliable, it slackens readily and is unable to support its own weight.

Referring now to FIG. 2A, there is shown a conveyor system 20 that transports a strip of precursor ceramic tape 21 to a cylindrical rod 23. The conveyor system 20 includes rollers 201 and support surfaces 202 that guide the strip 21 close to the former 23. A smoothly contoured surface 204 directs the tape 21 under the rod 23. When positioned at the conveyor system 20, an end block 231 supports the distal end of the rod to prevent it from bending and provides a rotary drive for rotating the rod 23 and a linear drive for translating the rod 23. After a tap 211 of sufficient length has passed a first pneumatically operated clamp 241 closes and fixes the tape 21 against the rod 23. Then the rod 23 is rotated and translated as indicated, while more tape is pushed through the conveyor system 20. Thus the end block 23 and the conveyor system 20 act as the a first mechanism for moving the tape 21 and the rod 23 relatively to each other.

The rod 23 acts as a primary or first former. Its diameter is chosen such that it matches the inner diameter of the primary helix.

The conveyor and the axis of the rod form an acute angle to feed tape at this angle onto the rod. As the strip is pushed by the conveyor across the rod 23, the rotation of the rod 23 causes the strip 21 to be wound around it. Simultaneously with the rotation, the rod 23 is moved in direction of its axis. Both motions are synchronized such that the tape is wound around the rod in a helical manner.

In FIG. 2B, the winding process of FIG. 2A is shown at a later stage with the tape 21 being wound around the former 23 for approximately half of its length. As the first clamp 241 is retracted from the conveyor system 20, a second spring-loaded clamp 242 is brought from below into contact with the tape. The second clamp has a slightly concave surface with a stop pin 243. The concave surface maintains pressure on the tape while the stop pin 243 prevents the slippage of tape along the rotating rod 23, thus ensuring that the helix remains tightly wound.

After the strip of tape 21 is fully wound around the primary former 23, the second end of the tape forms a second short stub (not shown) similar to the stub 211. The rod 23 is then moved by the linear drive of the block 231 to a second forming element. During the transport both clamps 241, 242 remain in place.

At the location of the second former 33, two clamps 351, 352 grip the tape at the stubs 211 as illustrated in FIG. 3A. The previous clamps 241, 242 are released and the forming rod 23 is moved in axial direction in sliding contact with an edge 353. The first former 23 is shown as a dashed outline. The first clamp 351 is fixed to the mounting block 331 that carries the second former 33. It pushes the stub 211 at one end of the tape 21 against the outer edge of the inner cylinder 332 of the second former 33. The combined clamp 351 and second former 33 are simultaneously rotated around the center axis of the cylindrical second former 33 and moved towards the second clamp 352 that rests immobile during this movement. Thus, the first clamp 351 and the second clamp 352 form the a second mechanism for moving said pre-formed tape and second forming element relatively to each other. As the second former 33 approaches the second clamp, more of the rod 23 slides over an edge 353 and more windings are pushed from the distal end of the rod. The windings are wound around the inner cylinder 332 of the rotating secondary former 33 until the tape is completely stripped of the primary former. At this stage, which is illustrated in FIG. 313, the pre-formed tape 21 is wound completely around the inner cylinder 332 of second former 33 and held in place by the two clamps 351, 352.

The inner cylinder 332 is spring-mounted within a bore of an outer cylinder 333 of the second former 33, such that pressure on the front face of the inner cylinder causes it to retract into the bore while the advancing sleeve of the outer cylinder pushes the wound tape 21 from the former.

At this stage of the process the twice-coiled actuator of FIG. 1 is completed in its “green” state. However to stabilize the structure, the tape 21 has to be at least dried. To free the second former 33, the wound helix is transferred into a tray or array for further handling off-line.

In FIG. 4, the secondary former 33 is shown approaching a array 40 of saggers 41. As the secondary former meets a sagger 41, the front face of its inner cylinder 332 (shown in FIG. 3 above) engages a matching cylinder 431 within a recess area 432 of a sagger 41. As the secondary former moves closer to a sagger, the spring-loaded inner cylinder 332 remains stationary and the outer ring 333 pushes the twice-coiled helix into the recess 432 of the sagger. The clamps that grip the stubs or ends of the tape open to release the helix. The outer boundary of the recess area 432 has a diameter that closely matches the nominal outer diameter of the major helix of the actuator. The edges of the boundary of the recess area are contoured or chamfered to assist the placing of the tape into the sagger. The sagger array 40 filled with fully formed green tape is then placed in a heated environment for drying and prepared for further processing stages such as sintering in an oven.

The various clamping devices described above are using pneumatically operated actuators commercially available for example from Festo. Commercially available DC servo motors are used to generate other movements of the components. All components are under the control of a computer program stored in and executed from an Intel processor based workstation.

Variations of the above example are readily within the scope of a skilled person. It is for example feasible to design the forming elements in a segmented manner to alter their diameter and hence the dimensions of the actuator. It is also possible to replace the second forming element with a removable sagger and thus wind the pre-formed tape directly onto the sagger.

1. A method of manufacturing a ceramic device comprising: transporting ceramic tape in a green state into the proximity of a first forming element; fixing a first end of said tape with respect to said first forming element; moving said tape and first forming element relatively to each other in a motion including simultaneously rotational and translational movements, thus winding said tape around said first forming element; removing said fixing of a first end thereby allowing separation of said tape and first forming element to generate a helically wound pre-formed tape; fixing at least one end of said pre-formed tape with respect to a second forming element; and moving said pre-formed tape and second forming element relatively to each other in a motion including at least a rotational movement, thus winding said pre-formed tape around said second forming element.

2. The method of claim 1, further comprising, during the step of moving said tape and first forming element relatively to each other, continuously pressing said tape onto said first forming element at a zone where said tape first contacts said first forming element.

3. The method of claim 2, further comprising, during the step of moving said tape and first forming element relatively to each other, exerting a force on the edge of the tape at a zone where said tape first contacts the first forming element to prevent slippage of said tape relative to said first forming element.

4. The method of claim 1, further comprising, between the step of moving said tape and first forming element relatively to each other and the step of removing said fixing of a first end, closing a second clamping element around the first end of the tape.

5. The method of claim 1, wherein the step of separating said tape and first forming element comprises moving the first forming element relatively to an edge holding back the pre-formed tape.

6. The method of claim 1, wherein, during the step of moving said pre-formed tape and second forming element relatively to each other, the pre-formed tape is held at both ends using clamping elements, one of said clamping elements fixing one end of said pre-formed tape with respect to the second forming element, the other clamping element performing a relative rotational movement around said second forming element.

7. The method of claim 1, further comprising the steps of removing the fixing with respect to the second forming element and transferring the wound pre-formed tape onto a support structure; and placing said support structure into environment for drying.

8. The method of claim 1, wherein the tape is handled by pneumatically operated devices.

9. The method of claim 1, wherein the step of moving said tape and first forming element relatively to each other comprises rotating the first forming element and translating the unwound portion of the tape towards the first forming element.

10. The method of claim 9, wherein the step of moving said tape and first forming element relatively to each other further comprises translating the first forming element along an axis about which the tape is wound.

11. The method of claim 1, wherein, in the step of moving said tape and first forming element relatively to each other, the tape is wound helically around the first forming element.

12. The method of claim 1, wherein the first forming element is cylindrical.

13. The method of claim 1, wherein the tape comprises layers of electro-active material.

14. An apparatus for manufacturing a ceramic device from tape in a green state, the apparatus comprising a first forming element; a first clamping system for fixing a first end of said tape with respect to said first forming element; a first mechanism for moving said tape and first forming element relatively to each other in a motion including simultaneously rotational and translational movements, thus winding said tape around said first forming element to form a preformed tape; a second forming element; a second clamping system for fixing at least one end of said pre-formed tape with respect to said second forming element; and a second mechanism for moving said pre-formed tape and second forming element relatively to each other in a motion including at least a rotational movement, thus winding said pre-formed tape around said second forming element.

15. The apparatus of claim 14, wherein the first clamping system includes a spring- loaded surface that in operation continuously presses the tape onto said first forming element at a zone where said tape first contacts said first forming element.

16. The apparatus of claim 15, wherein the spring-loaded surface is combined with a force-transmitting member adapted to contact the edge of the tape at a zone where said tape first contacts the first forming element to prevent slippage of said tape relative to said first forming element.

17. The apparatus of claim 14, further comprising a stripping edge making contact to the first forming element to separate said first forming element and the pre-formed tape.

18. The apparatus of claim 14, wherein the second clamping system includes a first clamping element for fixing a first end of the tape to the second forming element and a second clamping element for fixing the other end of the tape, the second mechanism being arranged to relatively rotate the second clamping element around said second forming element.

19. The apparatus of claim 18, further comprising one or more saggers having recesses adapted to support the formed tape during drying.

20. The apparatus of claim 14, wherein the clamping devices are pneumatically operated.

21. The apparatus of claim 14, wherein the first forming element is a cylindrical rod.

22. The apparatus of claim 14, wherein the first mechanism comprises a rotary drive arranged to rotate the first forming member and a conveyor system arranged to translate the tape towards the first forming member.

23. The apparatus of claim 22, wherein the first mechanism further comprises a linear drive arranged to translate the first forming member along an axis about which the tape is wound.

24. A ceramic structure made using methods or apparatus in accordance with claim 1.

25. The ceramic structure of claim 24 being an electro-active ceramic structure.
